(19) United States
(12) Patent Application Publication
(10) Pub. No.: US 2013/0151266 A1
(43) Pub. Date: Jun. 13, 2013

(54) SYSTEMS AND METHODS FOR COMMUNICATING AND MANAGING PATIENT PHYSIOLOGICAL DATA AND HEALTHCARE PRACTITIONER INSTRUCTIONS

(71) Applicants: Mary Ellen Randall, Cary, NC (US); Grayson W. Randall, Cary, NC (US); Ramanujanpuram Ramanujan, Binghamton, NY (US)

(72) Inventors: Mary Ellen Randall, Cary, NC (US); Grayson W. Randall, Cary, NC (US); Ramanujanpuram Ramanujan, Binghamton, NY (US)

(73) Assignee: ASCOT TECHNOLOGIES, INC., Cary, NC (US)

(21) Appl. No.: 13/314,304

(22) Filed: Dec. 8, 2011

(51) Int. Cl. G06Q 50/22

(52) U.S. Cl. 705/2

(57) ABSTRACT

Systems and methods for communicating and managing patient physiological data and healthcare practitioner instructions are disclosed. An example method may be implemented at a first electronic device for receiving patient physiological data. The first electronic device may also communicate the patient physiological data to a second electronic device of a healthcare practitioner. Further, the first electronic device may receive, from the second electronic device, healthcare practitioner instructions for communication to a third electronic device of a patient. The first electronic device may also communicate the healthcare practitioner instructions to the third electronic device.

### TECHNICAL FIELD

The present subject matter relates to healthcare systems. More particularly, the present subject matter relates to systems and methods for communicating and managing patient physiological data and healthcare practitioner instructions.

### BACKGROUND

Various systems are currently available that enable people to monitor their health in the home. For example, blood glucose monitoring devices are currently available for allowing people to self measure and monitor their blood glucose in the home. Such measures may be reported to healthcare practitioners for use in designing treatment plans for their patients.

In some systems, home medical monitoring devices may collect physiological data and store them in a repository, such as a remote server. Such data may be read from a specific device and subsequently input into a series of charts and graphs. The data may also be reported to a device of the patient's physician or another healthcare practitioner. Healthcare practitioners may then change treatment plans or prescribe new treatment plans for their patients based on data read from home medical monitoring devices. Although such systems have provided increased convenience and cost savings in healthcare, there remains a need for improvements in such systems to provide better communications between healthcare practitioners and their patients.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for communicating and managing patient physiological data and healthcare practitioner instructions. As an example benefit of the presently disclosed subject matter, a physician may receive patient physiological data collected at a patient's home or another site remote from the physician, and communicate instructions back to the patient's electronic device after reviewing the data. As a result, the physician can provide frequent feedback to the patient based on the collected data and improve treatment efficiency because the patient is not required to meet with the physician for receipt of such instructions. For example, according to an aspect, a method may be implemented by a suitable electronic device, such as a server connected to a communications network. The method includes receiving patient physiological data, such as from home health monitoring equipment. Further, the method also includes communicating the patient physiological data to another electronic device of a healthcare practitioner. The method also includes receiving, from the second electronic device, healthcare practitioner instructions for communication to a third electronic device of a patient. The method also includes communicating the healthcare practitioner instructions to the third electronic device.

According to another aspect, a method may be implemented by an electronic device of a patient. The method may include receiving patient physiological data. Further, the method may include presenting, via a user interface such as a display, the patient physiological data for communication to a healthcare practitioner for instructions in a treatment plan. The method may also include communicating the patient physiological data to a second electronic device of the healthcare practitioner. Further, the method may include receiving instructions from the second electronic device.

According to another aspect, a method may be implemented by an electronic device of a healthcare practitioner. The method may include communicating instructions for a treatment plan to a second electronic device of a patient. Further, the method may include presenting the healthcare practitioner instructions via a user interface of the third electronic device. The method may also include receiving, via the user interface of the third electronic device, patient confirmation of review of the healthcare practitioner instructions. Further, the method may include communicating the patient confirmation to the second electronic device in response to receiving patient confirmation.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the presently disclosed invention is not limited to the specific methods and instrumentalities disclosed. In the drawings:

FIGS. 1A and 1B illustrate a schematic diagram of a system for communicating and managing physiological data and healthcare practitioner instructions in accordance with embodiments of the present disclosure;

FIG. 2 is a block diagram of an example of the patient electronic device shown in FIG. 1A;

FIG. 3 is a block diagram of an example of the server shown in FIG. 1B;

FIG. 4 is a block diagram of an example of the healthcare practitioner electronic device shown in FIG. 1A;

FIG. 5 is a flow chart of an example method for communicating patient physiological data to an electronic device of a healthcare practitioner and receiving medical instructions in accordance with embodiments of the present disclosure;

FIG. 6 is a flow chart of an example method for communicating patient physiological data to an electronic device of a healthcare practitioner and for receiving medical instructions in accordance with embodiments of the present disclosure;

FIG. 7 is a flow chart of an exemplary method for communicating patient compliance information to an electronic device of a healthcare practitioner in accordance with embodiments of the present disclosure;

FIGS. 8-12 illustrate example screenshots that may be displayed by an electronic device in accordance with the embodiments of the present disclosure; and

FIG. 13 is a message flow diagram of example communications between a patient electronic device and a server in accordance with embodiments of the present subject matter.

### DETAILED DESCRIPTION

The present disclosure is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “electronic device” should be broadly construed. It can include any type of device capable of presenting an electronic document to a user. For example, an electronic device may be a computer configured to present physiological data to a user. Examples of such computer include, but are not limited to, conventional desktop computers as well as laptop computers. In another example, an electronic device may be a mobile device such as, for example, but not limited to, a smart phone, a cell phone, a pager, a personal digital assistant (PDA), a mobile computer with a smart phone client, or the like. An electronic device may also be a typical mobile device with a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, WAP, or BLUETOOTH®. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of mobile wireless devices. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats.

As referred to herein, the term “electronic document” should be broadly construed. An electronic document may be stored in any suitable format, such as, but not limited to, portable document format (PDF), hypertext markup language (HTML), extensible markup language (XML), EPUB, or any suitable electronic file or word processing format. Further, it is noted that when the term “electronic document” is recited herein, the term may also be substituted with the term “electronic file” or “e-file” or any other electronic document example disclosed herein, and vice versa.

As referred to herein, a “user interface” is generally a system by which users interact with an electronic device. An interface can include an input for allowing users to manipulate an electronic device, and can include an output for allowing the system to present information (e.g., electronic text) and/or data, indicate the effects of the user's manipulation, etc. An example of an interface on an electronic device includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. The display object can be displayed on a display screen of an electronic device and can be selected by, and interacted with by, a user using the interface. In an example, the display of the electronic device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or arrow keys for moving a cursor to highlight and select the display object.

Operating environments in which embodiments of the present disclosure may be implemented are also well-known. In a representative embodiment, a mobile electronic device, such as a laptop computer, is connectable (for example, via WAP) to a transmission functionality that varies depending on implementation. Thus, for example, where the operating environment is a wide area wireless network (e.g., a 2.5G network, a 3G network, or a 4G network), the transmission functionality comprises one or more components such as a mobile switching center (MSC) (an enhanced ISDN switch that is responsible for call handling of mobile subscribers), a visitor location register (VLR) (an intelligent database that stores on a temporary basis data required to handle calls set up or received by mobile devices registered with the VLR), a home location register (HLR) (an intelligent database responsible for management of each subscriber's records), one or more base stations (which provide radio coverage within a cell), a base station controller (BSC) (a switch that acts as a local concentrator of traffic and provides local switching to effect handover between base stations), and a packet control unit (PCU) (a device that separates data traffic coming from a mobile device). The HLR also controls certain services associated with incoming calls. Of course, embodiments in accordance with the present disclosure may be implemented in other and next-generation mobile networks and devices as well. The mobile device is the physical equipment used by the end user, typically a subscriber to the wireless network. Typically, a mobile device is a 2.5G-compliant device, 3G-compliant device, or 4G-compliant device that includes a subscriber identity module (SIM), which is a smart card that carries subscriber-specific information, mobile equipment (e.g., radio and associated signal processing devices), a user interface (or a man-machine interface (MMI)), and one or more interfaces to external devices (e.g., computers, PDAs, and the like). The electronic device may also include a memory or data store.

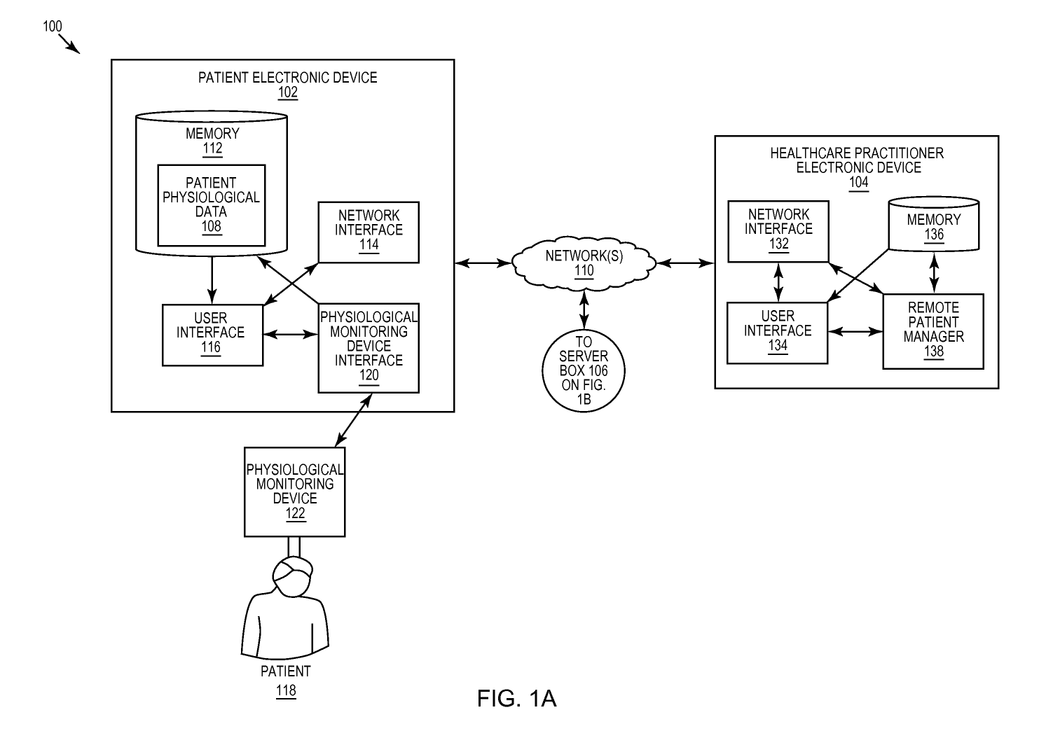

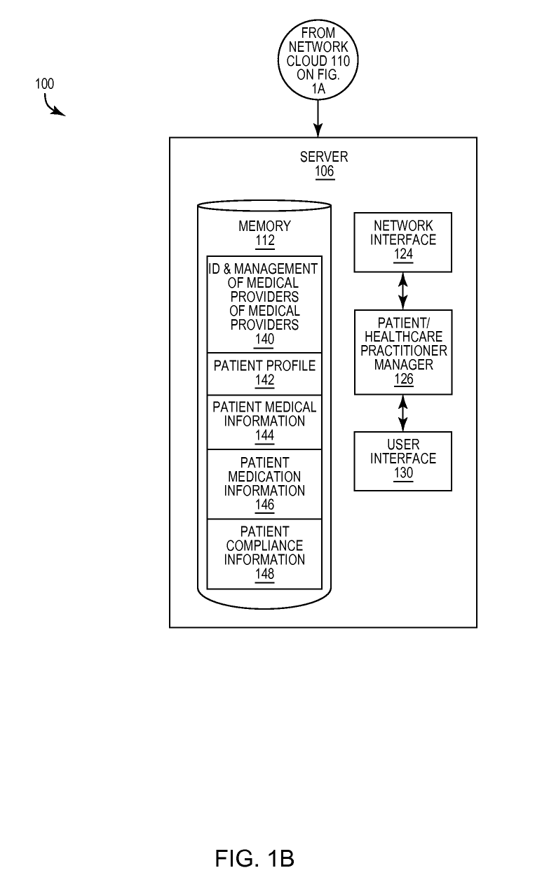

The presently disclosed subject matter is now described in more detail. For example, FIGS. 1A and 1B illustrate a schematic diagram of a system 100 for communicating and managing physiological data and healthcare practitioner instructions in accordance with embodiments of the present disclosure. Physiological data may include, but is not limited to, blood pressure and glucose readings. Such readings may be collected at a patient's home and subsequently communicated to a repository, such as a remote server, for access by a healthcare practitioner, who may suitable review the data in tabular, graphic formats, or any other suitable technique for presenting data. As referred to herein, the term “healthcare practitioner” may be a physician, a nurse, a physician's assistant, or any other individual that provides healthcare instructions or information to a patient. In this example, the patient is currently engaged in receipt of medical treatment by the healthcare practitioner. The healthcare practitioner in this example has prescribed a treatment plan for the patient. After reviewing the data the healthcare practitioner may enter instructions for modifying existing prescription dosages for communication to the patient. A patient may use his or her electronic device for confirming receipt of the instructions.

Referring to FIGS. 1A and 1B, the system 100 includes a patient electronic device 102 configured to receive and communicate patient physiological data to, and receive medical instructions from, a healthcare practitioner electronic device 104 via a network 110. The patient electronic device 102 may also be configured, using a physiological monitoring device interface 120, to communicate with a physiological monitoring device 122 and to receive and store patient physiological data 108 in its memory 112. The collected data may be time stamped. Further, the electronic device may be configured to receive data from multiple different types of physiological monitoring devices. The interface 120 may be, but is not limited to, a USB connection, a serial connection, or BLUETOOTH® wireless connection suitable for communicative connection to one or more physiological monitoring devices. In this example, electronic devices 102 and 104 are computers (e.g., laptop or tablet computers), but may alternatively be any other suitable electronic device configured to communicate electronic data to another electronic device and receive medical instructions or other data from another electronic device. A user of the patient electronic device 102 may interact with a user interface 116 to view or otherwise be presented with patient physiological data and select the healthcare practitioner electronic device 104 as the intended recipient of that data. In response, a user of the healthcare practitioner electronic device 104 may interact with a user interface 134 to view patient physiological data and to select the patient electronic device 102 as the intended recipient of medical instructions based on the received physiological data 108. Both the patient electronic device 102 and the physician electronic device 104 may be configured to communicate with a server 106 via a network 110. The server 106 can store both the patient physiological data 108 and any corresponding medical instructions on its memory 112 which may allow both the patient electronic device 102 and the healthcare practitioner electronic device 104 to access all permitted data at a given time.

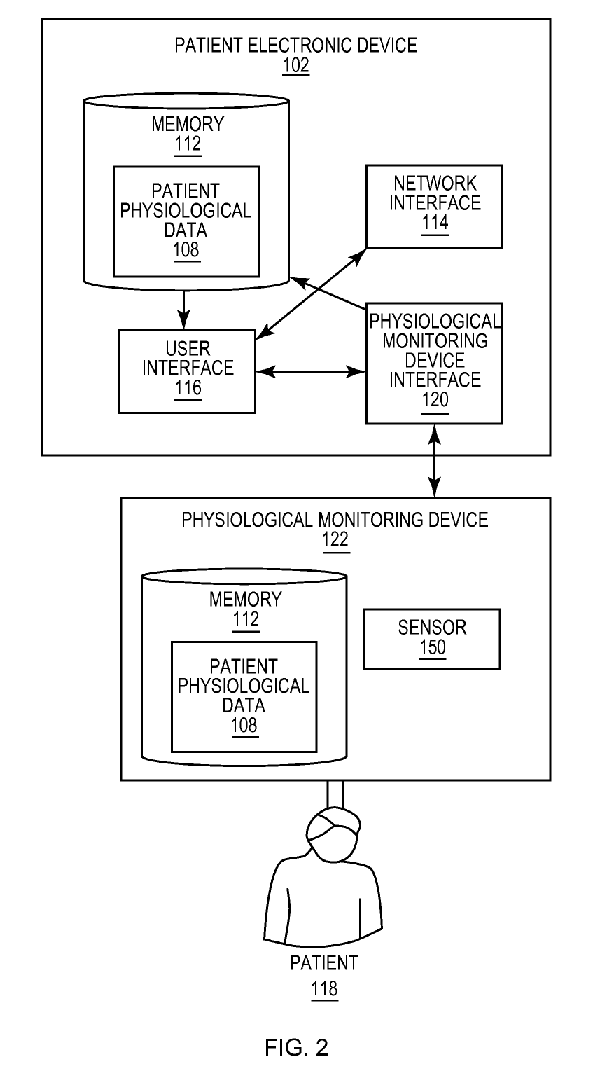

In accordance with the embodiments of the present disclosure, FIG. 2 illustrates a block diagram of an example of the patient electronic device 102 shown in FIG. 1A. Referring to FIG. 2, the patient electronic device 102 includes a physiological monitoring device interface 120 configured to provide a communication interface between the patient electronic device 102 and the physiological monitoring device 122. In an example operation, the physiological monitoring device 122 may measure physiological data from a patient 118 with a sensor 150. For example, the physiological monitoring device 122 may obtain data from the patient 118 including but not limited to, blood pressure, pulse, glucose level, or the like along with a time the readings were taken. The physiological monitoring device 122 may store the data in its memory 112 and suitably communicate the data to the patient electronic device 102 where the data is stored in the memory 112 of the patient electronic device 102. The user interface 116 may subsequently present the data to the patient or another user of the patient electronic device 102. In addition, the patient may input commands by use of the user interface 116 for communicating the data to the server 106 for subsequent communication to the healthcare practitioner electronic device 104 as described in more detail herein. The network interface 114 of the device 102 may communicate the data to the server 106 via the network 110.

In an embodiment, each patient may have a high and low compliance threshold value assigned to their physiological data, such as their blood pressure readings. Such threshold values may be configurable by a healthcare practitioner. Measurements or readings outside the threshold may be color-coded for ease of viewing when read on an electronic device of the healthcare practitioner. It is noted that this embodiment is an example implementation of the presently disclosed subject matter and not necessarily required by any of the other embodiments or examples described herein.

The patient electronic device 102 may also be configured to receive medical instructions or other data or information from the healthcare practitioner electronic device 104. For example, the network interface 114 of the patient electronic device 102 may receive the data from the network 110. In response to receipt of medical instructions, the user interface 116 may present the medical instructions to the user via the user interface 116. For example, in response to receiving the instructions, the user interface 116 may suitably display the instructions to the user, or may display a notification indicating that instructions have been received and are available for review.

The patient electronic device 102 may be configured for authenticating and encrypting medical information, such as the physiological data 108. Further, the device 102 may be configured to manage collection of and assure delivery of data to a device of a healthcare practitioner. Further, the device 102 may track and log all or at least some of the steps associated with communicating data to the healthcare practitioner.

In an example, the device 104 may track compliance of each patient with instructions provided by the healthcare practitioner. The device 104 may also include an integrated workflow management tool for tracking patient tasks associated with a particular healthcare practitioner.

In an example, a patient may take his or her blood pressure and/or glucose readings by use of a physiological monitoring device. Subsequently, the patient may communicatively connected the physiological monitoring device with an electronic device, such as the device 102. By suitable interaction with the electronic device such as selection of a displayed icon or button, the electronic device locates and reads the physiological data from the physiological monitoring device and subsequently communicates the data to a server, such as the server 106. Such communication may be secured and authenticated. The data is tracked and validated to ensure it is correctly delivered to the server. The electronic device may then wait for a request to send additional data. Further, the electronic device may poll the server to look for healthcare practitioner instructions, such as any changes to the medications associated with the patient. If instructions are found, the medication changes are delivered to the electronic device and recorded for the patient to review and implement. The electronic device may prompt the patient to acknowledge the instructions (e.g., the medication change). The times of each event are recorded on the server, such as by time stamp.

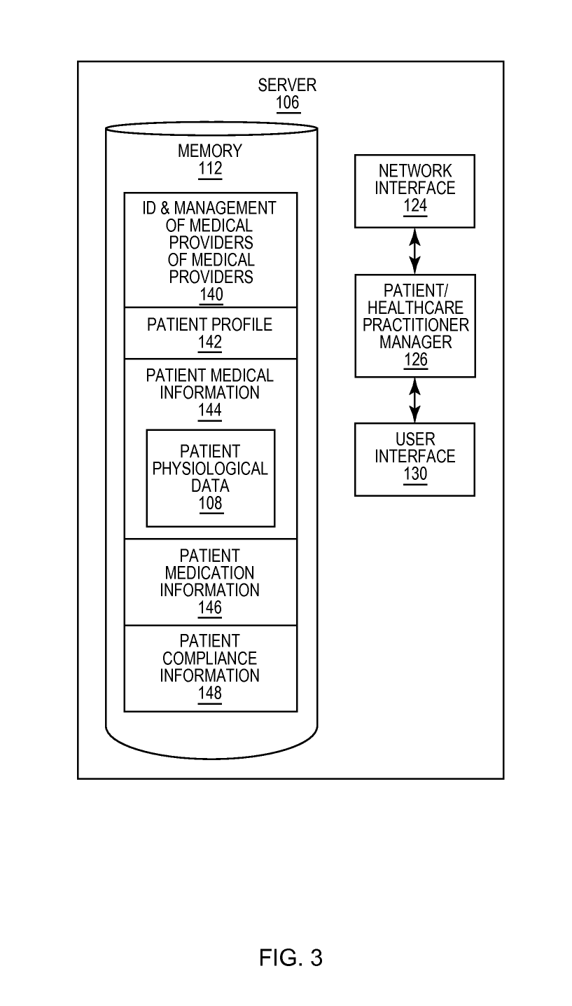

In accordance with the embodiments of the present disclosure, FIG. 3 illustrates a block diagram of an example of the server 106 shown in FIG. 1B. Referring to FIG. 3, the server 106 includes a network interface 124 configured for communication with a network, such as the network 110 shown in FIG. 1A. The server 106 may include a patient/healthcare practitioner manager 126 that is configured to store patient physiological data 108 received from a patient electronic device. The data 108 may be stored in the memory 112. The data 108 may be stored within a patient medical information portion 144 of the memory 112. The patient medical information 144 may also include any other suitable patient medical information such as, but not limited to, contact information and account information. Further, the information 144 may include healthcare practitioner instructions for patients as disclosed herein. The instructions, pending a request from either the patient electronic device 102 or the physician electronic device 104 may be communicated via the network 110. The server 106 is configured to manage these requests with the manager 126 which is configured to manage information such as, but not limited to, an identifier (ID) of approved medical providers 140, patient profiles 142, patient medical information and history, which may include patient physiological data 108, changes to patient medications, patient compliance with physician instructions, and the like, that may be stored in the memory 112. The memory 112 may also store patient medication information 148 and patient compliance information 148, all of which may be managed and controlled by the manager 126. The information stored in the memory 112 can be displayed via the user interface 130, but may also be accessible to the healthcare practitioner electronic device 104 or the patient electronic device 102 via a suitable technique.

In an example, a server may store and manage medical data, staff, patients, tracking information, and workflow items. Further, the server may authenticate requests from electronic devices (e.g., devices 102 and 104), and may load data or information received from the devices into its memory 112. Any patient information that is received may be displayed in a list such that a healthcare practitioner can see which patients have sent data to be reviewed. The server may support requests for medication status. After authenticating each request, the server may check for any changes to the patient's medications. The server may return the results to the patient's electronic device for display to the patient.

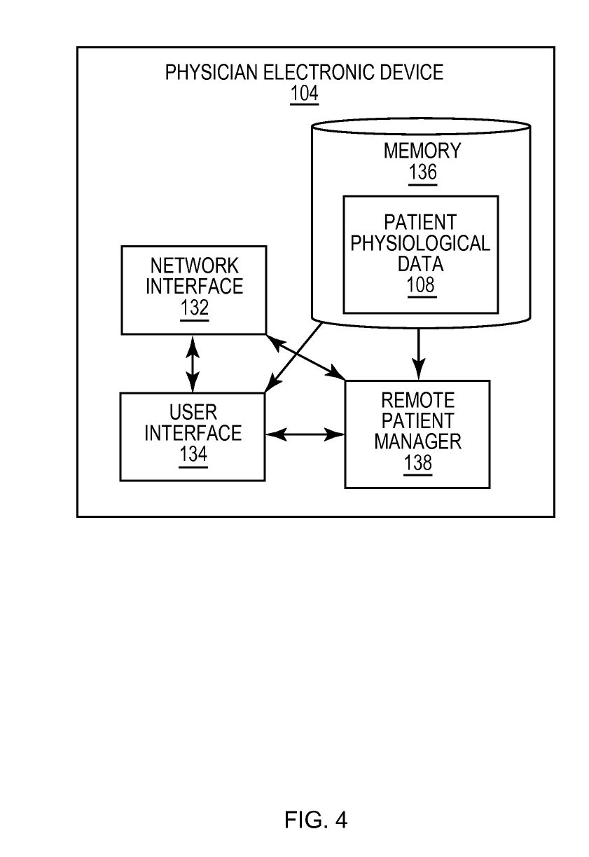

In accordance with the embodiments of the present disclosure, FIG. 4 illustrates a block diagram of an example of the healthcare practitioner electronic device 104 shown in FIG. 1A. Referring to FIG. 4, the physician electronic device 104 includes a network interface 132 configured to communicate with other electronic devices via a network, such as the network 110 shown in FIG. 1A. A user of the device 104 may interact with the user interface 134 for requesting patient physiological data 108 from a server, such as the server 106 shown in FIG. 1B. For example, the network interface 132 may communicate a request for the data in response to receipt of a command for requesting data from the server. Alternatively, the data may be automatically communicated to the device 104 from the server 106. In response to receipt of the data, the user interface 134 may suitably display or otherwise present the patient physiological data 108 to the user via the user interface 134. The user of the physician electronic device 104 may view the patient physiological data 108. Subsequently, the user may input medical instructions associated with a treatment plan for the corresponding patient via the user interface 134 for communication to a patient electronic device, such as the device 102 shown in FIG. 1A. Additionally, a remote patient manager 138 configured to manage information, such as approved medical providers and patient medical information, that may be stored within the memory 136.

In an example, the electronic device of the healthcare practitioner may implement an application that provides a user interface function for allowing the healthcare practitioner to use an HTTP-based browser to manage the system, manage patient data and medications, and track multiple events in the system. The application may provide one or more of the following functions: manage staff profiles, manage patient profiles, track patient compliance, display data for a patient, change medications for a patient, workflow management, and output patient information as a suitable file (e.g., a PDF file). The electronic device may notify the healthcare practitioner of high or low readings (e.g., readings that meet or exceed a predefined threshold).

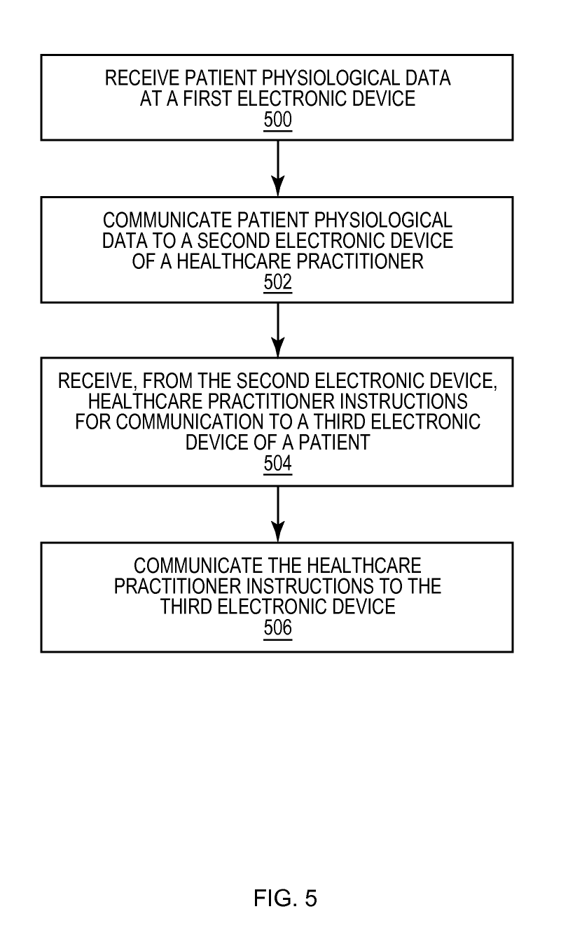

FIG. 5 illustrates a flow chart of an example method for communicating patient physiological data to an electronic device of a healthcare practitioner and receiving medical instructions in accordance with embodiments of the present disclosure. The method of FIG. 5 is described with respect to the example system of FIGS. 1A and 1B, although the method may be implemented by any suitable system or electronic device. In an example, various steps of FIG. 5 may be implemented entirely, or in part, by the healthcare practitioner/physician manager 126 residing on the server 106 shown in FIG. 3. The healthcare practitioner/physician manager 126 may be implemented by software, hardware, firmware, or any combination thereof.

Referring to FIG. 5, the method includes receiving patient physiological data 108 at a first electronic device (step 500). For example, the network interface 124 of the server 106 shown in FIG. 1B may receive patient physiological data 108 from a patient electronic device, such as the device 102 shown in FIG. 1A. The server 106 may store the data in its memory 112. Subsequently, the stored data may be retrieved by request from a healthcare practitioner by use of his or her device as disclosed herein.

The method of FIG. 5 includes communicating patient physiological data 108 to a second electronic device (step 502). For example, the manager 126 may communicate stored patient physiological data to the physician electronic device 104 in response to receipt of a request from the data from the healthcare practitioner's device. Alternatively, for example, the data may be automatically communicated to the healthcare practitioner's device in response to receipt of the data from the patient's device.

The method displayed in FIG. 5 also includes receiving, from the second electronic device, healthcare instructions for communication to a third electronic device of a patient (step 504). In addition, the method shown in FIG. 5 includes communicating healthcare instructions to a third electronic device (step 506). For example, subsequent to the server 106 receiving the healthcare instructions, the instructions may be communicated to the patient electronic device 102 for presentation to the patient. These instructions may be communicated to the server 106 via the network 110 as described in the example provided herein.

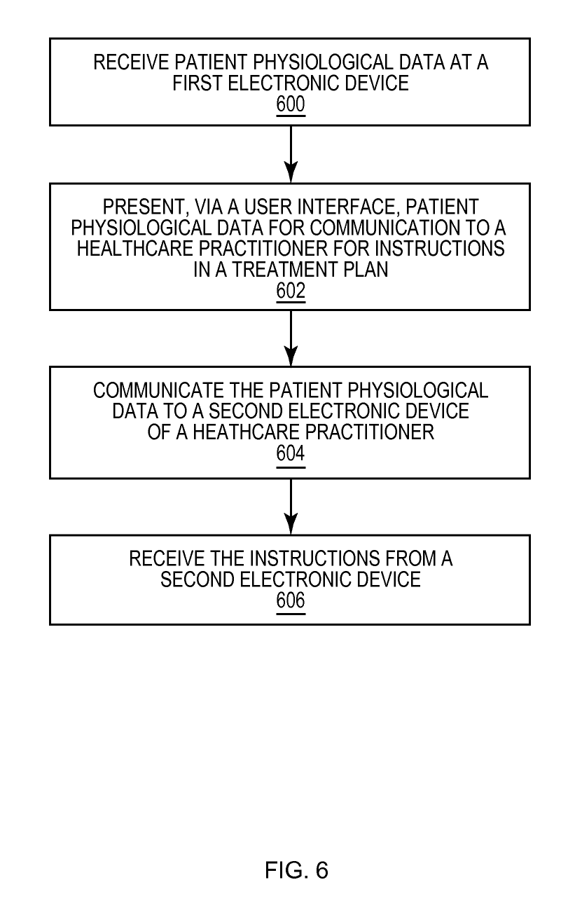

FIG. 6 illustrates a flow chart of an example method for communicating patient physiological data to an electronic device of a healthcare practitioner and for receiving medical instructions in accordance with embodiments of the present disclosure. The method of FIG. 6 is described with respect to the example system of FIG.1, although the method may be implemented by any suitable system or electronic device. Various steps of FIG. 6 may be implemented entirely, or in part, by the electronic device 102 shown in FIG. 2.

Referring to FIG. 6, the method includes receiving patient physiological data 108 at a first electronic device (step 600). For example, the patient electronic device 102 may receive patient physiological data 108 from the physiological monitoring device 122 after the sensor 150 interacts with the patient. The physiological monitoring device 122 may communicate the patient physiological data 108 to the patient electronic device 102 via the physiological monitoring device interface 120.

The method of FIG. 6 includes presenting patient physiological data via the user interface 116 for communication to a healthcare practitioner for instructions in a treatment plan (step 602). For example, subsequent to submitting the patient physiological data 108 to the healthcare practitioner electronic device 104, the patient electronic device 102 user may review the patient physiological data 108 for errors. The patient physiological device 102 user may then interact with the user interface 116 for selecting the physician electronic device 104 from among a list of approved recipients for submission of the patient physiological data 108.

The method displayed in FIG. 6 includes communicating the patient physiological data 108 to a second electronic device of a healthcare practitioner (step 604). For example, the patient electronic device 102 may communicate the patient physiological data 108 to the healthcare practitioner electronic device 104 for review by a healthcare practitioner.

Finally, the method of FIG. 6 includes receiving instructions from the second device. For example, subsequent to receipt of the patient physiological data 108, the physician electronic device 104 may present the data to the healthcare practitioner. Further, the healthcare practitioner electronic device 104 may receive instructions via the user interface 134. Subsequent to entry of the instructions, the instructions may be suitably communicated to the patient electronic device 102.

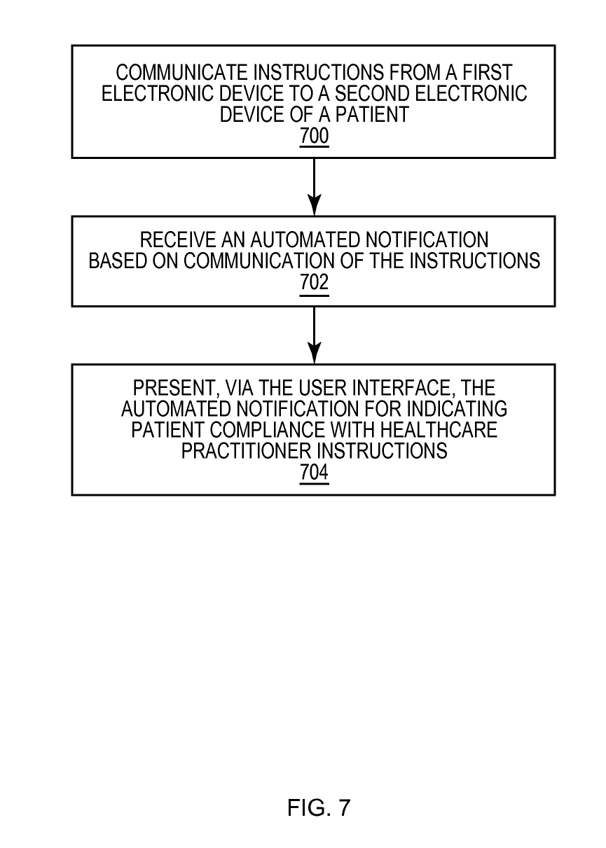

FIG. 7 illustrates a flow chart of an exemplary method for communicating patient compliance information to an electronic device of a healthcare practitioner in accordance with embodiments of the present disclosure. The method of FIG. 7 is described with respect to the example system of FIG. 1, although the method may be implemented by any suitable system or electronic device. Various steps of FIG. 7 may be implemented entirely, or in part, by the remote patient manager 138 residing on the server 106 shown in FIG. 1A.

Referring to FIG. 7, the method includes a first electronic device communicating instructions to a second electronic device (step 700). For example, the electronic device 104 may communicate medical instructions to the patient electronic device 102 after presentation of the patient physiological data 108 to a healthcare practitioner. The healthcare practitioner may enter the instructions after receipt of the patient physiological data 108 and presentation of the data to the practitioner.

The method of FIG. 7 includes receiving an automated notification based on the communication of the instruction (step 702). For example, subsequent to receipt of the medical instructions by the patient electronic device 102, an entry may be made at the server 106 that the instructions were received and a message may be communicated to the physician electronic device 104 that the instructions were received. The user of the electronic device 102 may suitably review the instructions and enter an acknowledgement of review of the instructions for indicating compliance with the instructions. In response to entry of the acknowledgement, the electronic device 102 may communicate an acknowledgement message to the electronic device 104.

The method of FIG. 7 includes presenting, via the user interface, the automated notification for indicating patient compliance with healthcare practitioner instructions. For example, the physician electronic device 104 may automatically present a notification via the user interface 134 in response to receipt of an acknowledgement message from the electronic device 102. This notification may provide the healthcare practitioner with confirmation that the instructions have been received and possibly complied with by the patient. Alternatively, if the healthcare practitioner is not provided with the notification, the healthcare practitioner may recognize that the instructions have not been received or complied with by the patient.

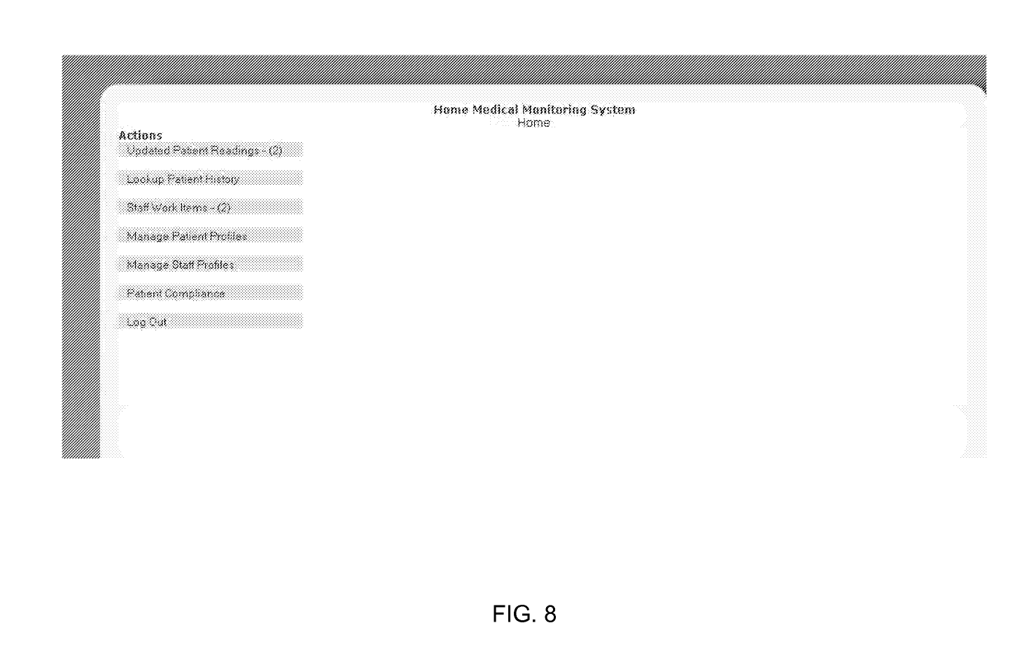

FIGS. 8-12 illustrate example screenshots that may be displayed by an electronic device in accordance with the embodiments of the present disclosure. For example, FIG. 8 is a screenshot of the home web page presented via the user interface and viewed by an authorized healthcare practitioner when there is patient physiological data to be presented. The home web page and other example screenshots may be presented to the patient via suitable interface with a website managed by a suitable network server. This home page includes a series of icons at the left of the screen which allow the user to engage in permitted actions such as, but not limited to, viewing patient physiological data, looking up past patient data, reviewing patient compliance with communicated medical instructions, and managing patient profiles. This home page is a gateway to confidential patient information and can only be accessed by logging into the page with an authorized name and password.

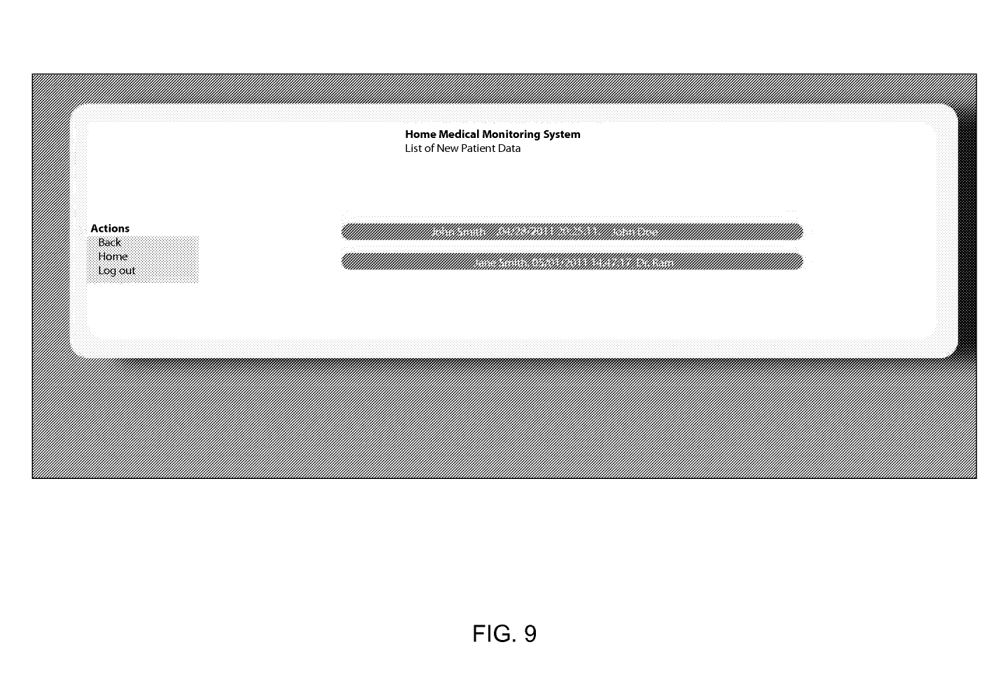

The example screenshot of FIG. 9 depicts an action implemented in response to selection of the “Updated Patient Readings” icon displayed in FIG. 8. The screenshot of FIG. 9 presents available patient physiological data that may be communicated or has been communicated to the electronic device of the healthcare practitioner. By accessing this page, a healthcare practitioner can remotely monitor the health and status of several patients without the requirement of examining each patient individually, or expend additional time examining each patient manually. The patient physiological data presented in FIG. 9 also includes a date and time stamp, which provides the healthcare practitioner with added insight beyond raw patient physiological data.

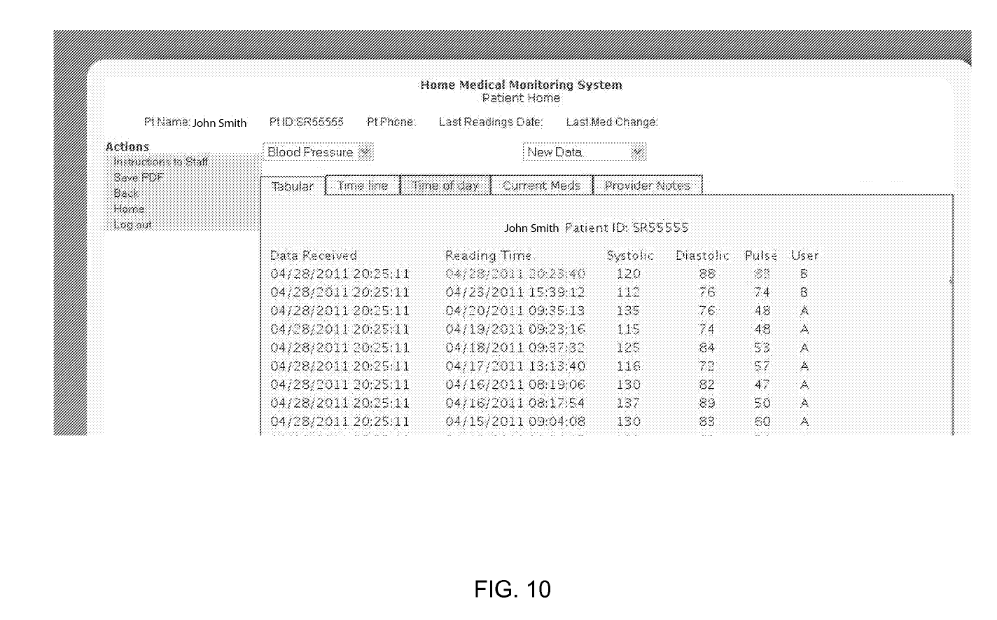

The example screenshot of FIG. 10 depicts an action in response to selection of a specific patient data file from the available data sets shown in FIG. 9. This web page displays patient physiological information in a tabular format and may include, but is not limited to, the time the data was collected, the time the data was received, the user who was logged into the patient electronic device at the time the data was communicated, and some or all patient physiological data that was communicated to the healthcare practitioner electronic device. There are a number of tabs across the top of the patient data table which include separate displays for additional information. By selection of these tabs, a healthcare practitioner can review a patient-specific treatment plan, monitor current medication, enter notes for medical changes, and the like.

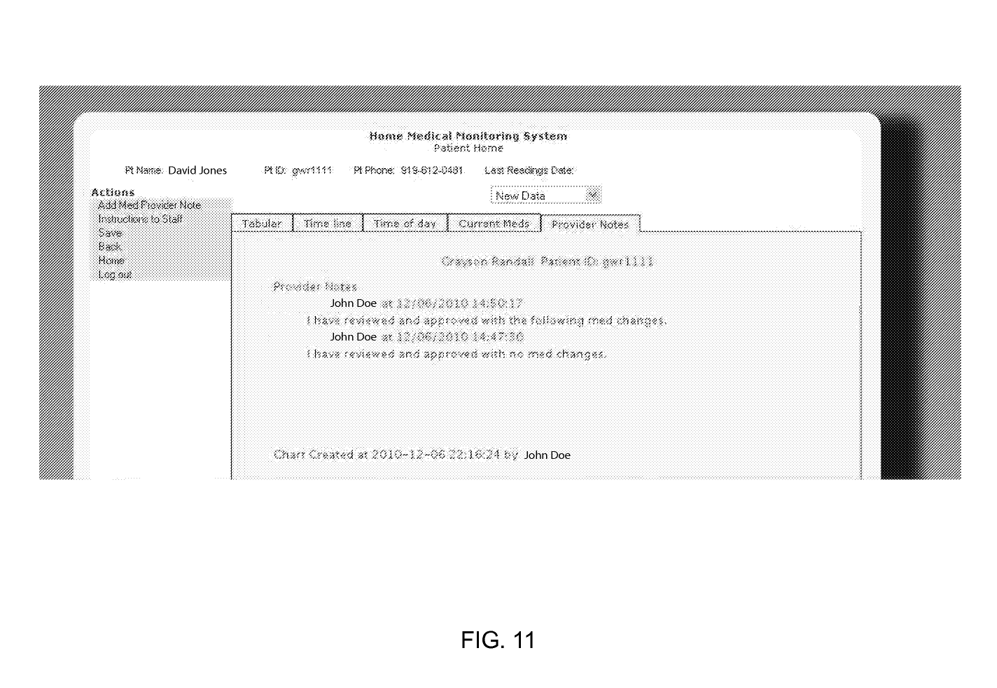

The example screenshot of FIG. 11 depicts an action implemented in response to selection of the tab entitled “Provider Notes” shown in FIG. 10. This screen allows the healthcare practitioner to review previous commentary on the patient and any changes in the patient treatment plan. By presenting this information in one, easy to access location, a healthcare practitioner can quickly and efficiently determine whether a particular data set follows a pattern of previous activity or is an isolated incident that can either be explained or examined further. The recorded notes also include an identifier so other healthcare practitioners can know who to contact if the need arises.

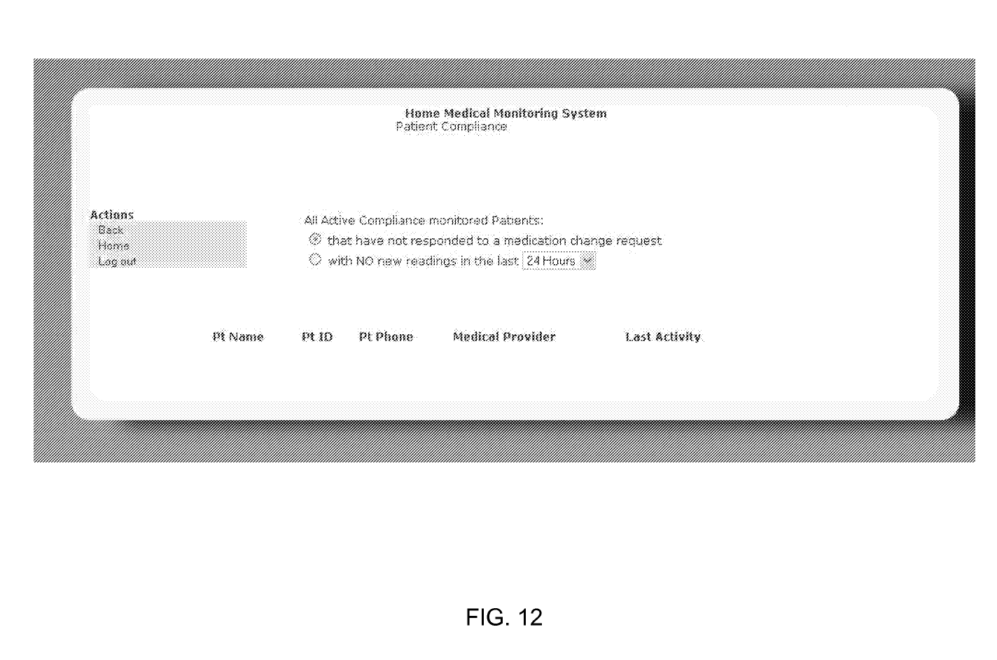

The example screenshot of FIG. 12 depicts an action in response to selection of the “Patient Compliance” icon shown in FIG. 8. In response to the healthcare provider entering medical instructions under the “Provider Notes” tab shown in FIG. 11, the instructions may be communicated to the patient electronic device via a network. The patient electronic device may subsequently display a notification on its user interface to indicate the arrival of medical instructions to the patient, who may then review the instructions and enter acknowledgement of and/or compliance with the instructions. After entry of acknowledgement and/or indication of compliance with the instructions, a notification may be automatically communicated to the server and/or the healthcare practitioner electronic device.

Also shown in FIG. 12 are options that a healthcare practitioner may have in monitoring the compliance status of patients. The healthcare provider can query the server for a list of patients with outstanding medical instruction notifications, or the query may be for a list of patients who have no communicated physiological data readings in an adjustable period of time, shown in FIG. 12 as 24 hours. This component may allow patients and healthcare providers to be in contact while avoiding costly and time-intensive travels to the healthcare practitioner's workplace.

In an example application, system and method embodiments disclosed herein may be used by patients with known or suspected hypertension or diabetes that a physician wants to monitor blood pressure, pulse, and/or blood glucose at home. Electronic devices disclosed herein may be software-based and be implemented with a computer running a suitable operating system. The electronic device may receive readings from supported government-approved devices in the home and may serve as a remote communication link between the home and the physician or qualified healthcare practitioners. The physician or healthcare practitioner can review patient information from a web interface and may make medication changes and transmit those changes back to the patient for display on the patient's electronic device. In an example, the medical device receives blood pressure, heart rate and blood glucose readings from the supported government-approved medical devices via USB or serial connection to the device 102. The patient's electronic device may communicate with a server as disclosed herein via, for example, suitable wireless or wired communication protocols such as cellular data, and wired or wireless Internet. A patient's electronic device may work with any suitable monitoring devices. The patient's electronic device may use any suitable communication protocols and encryption techniques for protecting patient privacy.

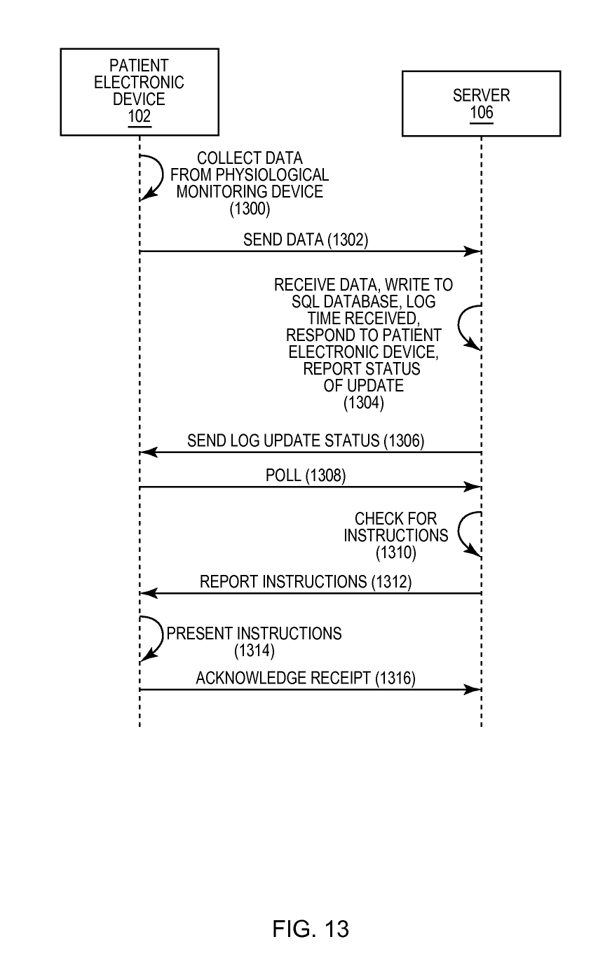

FIG. 13 illustrates a message flow diagram of example communications between the patient electronic device 102 and the server 106 in accordance with embodiments of the present subject matter. Referring to FIG. 13, the patient electronic device 102 may collect physiological data from a physiological monitoring device (step 1300). Subsequently, the physiological data may be sent to the server 106 (step 1302). The server 106 may receive the data and write the data to a suitable database, such as an SQL database (step 1304). In addition, at step 1304, the server 106 may log the time that the data was received. The server 106 may also send the data and associated time information to an electronic device of a healthcare practitioner. Step 1304 may also include responding to the patient electronic device 102 by reporting a status of the update at step 1306 where a log of the status of the patient's data is sent to the device 102.

Subsequently, the patient electronic device 102 may poll the server 106 (step 1308). In response to receipt of the poll, the server 106 may check for instructions from a healthcare practitioner associated with the patient (step 1310). The server 106 may then report any instructions, such as instructions not previously reported, to the device 102 (step 1312). In response to receipt of the instructions, the device 102 may present the instructions to the patient (step 1314). The patient may review the instructions. Further, the device 102 may provide an interface for the patient to acknowledge receipt and review of the instructions. In response to receipt of the patient's acknowledgement, the device 102 may send a message to the server 102 for acknowledging receipt of the instructions (step 1316). The server 106 may subsequently send indication to the healthcare practitioner electronic device for indicating receipt and/or compliance with the instructions.

In one or more embodiments, a healthcare practitioner, such as a dietician, may enter diet-related information for a patient into a patient profile, such as patient profile 142 shown in FIG. 1. Such information may be accessed by the dietician using an electronic device such as the electronic device 104. The dietician may use the information and other information such as physiological data, such as blood pressure information, to determine a diet for the patient. For example, if the data indicates that the patient has high blood pressure, the dietician may enter a recommended menu for the patient and suitably use the device 104 to send the menu to the patient for meal planning purposes. The patient profile 142 may also include patient food preferences and/or allergy information. The dietician may also use this information for recommending a menu.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method comprising:
at a first electronic device:
receiving patient physiological data;
communicating the patient physiological data to a second electronic device of a healthcare practitioner;
receiving, from the second electronic device, healthcare practitioner instructions for communication to a third electronic device of a patient; and
communicating the healthcare practitioner instructions to the third electronic device.

2. The method of claim 1, wherein communicating the healthcare practitioner instructions comprises communicating the healthcare practitioner instructions to the third electronic device via a network.

3. The method of claim 1, wherein receiving the patient physiological data comprises receiving the patient physiological data from the third electronic device, and
wherein the method further comprises presenting, at the second electronic device, a notice of receipt of the physiological data in response to receiving the physiological data at the first electronic device.

4. The method of claim 3, further comprising:
receiving, via a user interface of the second electronic device, input for acknowledging review of the patient physiological data;
presenting, via the user interface, one or more prompts for receiving the healthcare practitioner instructions for use in a treatment plan;
receiving the instructions via the user interface; and
communicating the instructions to the third electronic device.

5. The method of claim 1, at the third electronic device:
receiving the healthcare practitioner instructions;
presenting the healthcare practitioner instructions via a user interface of the third electronic device;
receiving, via the user interface of the third electronic device, patient confirmation of review of the healthcare practitioner instructions; and
in response to receiving patient confirmation, communicating the patient confirmation to the second electronic device.

6. A method comprising:
at a first electronic device:
receiving patient physiological data;
presenting, via a user interface, the patient physiological data for communication to a healthcare practitioner for instructions in a treatment plan;
communicating the patient physiological data to a second electronic device of the healthcare practitioner; and
receiving instructions from the second electronic device.

7. The method of claim 6, further comprising receiving, via the user interface, input for communicating the physiological data to the first electronic device, and
wherein communicating the patient physiological data comprises communicating the patient physiological data to the second electronic device in response to receiving the input.

8. The method of claim 6, wherein receiving the patient physiological data comprises receiving the patient physiological data from at least one physiological monitoring device.

9. The method of claim 8, further comprising:
at the at least one physiological monitoring device:
using a sensor to detect the patient physiological data;
storing the detected patient physiological data; and
transmitting the patient physiological data to the first electronic device.

10. A method comprising;
at a first electronic device:
communicating instructions for a treatment plan to a second electronic device of a patient;
determining receipt of acknowledgement of the instructions; and
presenting, via a user interface, a notification for indicating acknowledgement of the instructions.

11. The method of claim 10, wherein communicating instructions comprises communicating the instructions via a network.

12. The method of claim 10, wherein presenting a notification comprises displaying an indicator for notifying a user of receipt of the acknowledgement of the instructions.

13. An electronic device comprising:
a network interface configured to:
receive patient physiological data from a patient device via a network;
communicate the patient physiological data to a healthcare practitioner electronic device via the network; and
receive, from the healthcare practitioner electronic device, healthcare practitioner instructions for communication to the patient device.

14. The electronic device of claim 13, wherein the network interface is configured to receive the patient physiological data from the patient device.

15. The electronic device of claim 13, wherein the network interface is configured to:
receive input for acknowledging review of the patient physiological data; and
receive the healthcare practitioner instructions for use in a treatment plan; and
wherein the network interface is configured to communicate the instructions to the patient device.

16. An electronic device comprising:
a physiological monitoring device interface configured to receive patient physiological data;
a user interface configured to present patient physiological data for communication to a healthcare practitioner for instructions in a treatment plan; and
a network interface configured to:
communicate the patient physiological data to another electronic device of the healthcare practitioner; and
receive instructions from the other electronic device.

17. The electronic device of claim 16, wherein the user interface is configured to receive input for communicating the physiological data to the other electronic device, and
wherein the network interface is configured to communicate the patient physiological data to the other electronic device in response to receiving the input.

18. An electronic device comprising:
a remote patient manager configured to:
receive patient physiological data from a physiological monitoring device;
communicate the patient physiological data between electronic devices; and
receive healthcare practitioner instructions from one of the electronic devices; and
a network interface configured to communicate the data and the instructions to another electronic device among the electronic devices.

19. The electronic device of claim 18, wherein the network interface is configured to communicate the instructions via a network.

20. The electronic device of claim 18, further comprising a user interface configured to display an indicator for notifying a user of receipt of the acknowledgement of the instructions.
